(19) United States
(12) Patent Application Publication
(10) Pub. No.: US 2022/0378651 A1
(43) Pub. Date: Dec. 1, 2022

(54) ELECTROMAGNETIC TRANSDUCER FOR TRANSMITTING A VIBRATORY STIMULUS TO A USER AND A STIMULATION SYSTEM COMPRISING SUCH A TRANSDUCER

(71) Applicant: PGA Electronic, Montierchaume (FR)

(72) Inventor: Bruno PALACIO, Montierchaume (FR)

(21) Appl. No.: 17/804,401

(22) Filed: May 27, 2022

(30) Foreign Application Priority Data
May 31, 2021 (FR) 2105702

(51) Int. Cl. A61H 23/02; B64D 11/06

(52) U.S. Cl. CPC A61H 23/0218; B64D 11/06; A61H 2201/0176; A61H 2201/5082; A61H 2201/0149

(57) ABSTRACT

An electromechanical transducer for a stimulation system includes: a housing; a movable element mounted inside the housing and capable of being moved in translation by means of at least a first elastic return element; an electromagnetic actuation system, including an electromagnet and a first magnet. The electromagnet is integral with the movable element. The first elastic return element includes a thermally insulating material. The electromechanical transducer further includes a heat-sensitive element associated with the electromagnet. Further, a stimulation system comprises the electromagnetic transducer and a vehicle including such a stimulation system.

### CROSS-REFERENCE TO RELATED APPLICATIONS

This application claims the benefit of French Patent Application No. 2105702 filed on May 31, 2021, the entire disclosure of which is hereby incorporated by reference herein.

### TECHNICAL FIELD

The invention relates to the field of stimulation systems intended for the transmission of vibratory stimuli to users, such as for example massage and/or multimedia chairs.

The invention relates more specifically to an electromagnetic transducer, a stimulation system comprising such an electromagnetic transducer, and a vehicle integrating such a stimulation system.

### PRIOR ART

Tactile/vibratory stimulation systems, such as massage and/or multimedia chairs, are known to be equipped with electromagnetic transducers in order to transmit, to the users of said stimulation systems, vibratory stimuli contributing to a massaging gesture or to sensory transmissions related to a media consumed by the user or an informative media.

The term ‘vibratory stimulus’ is understood here and in the remainder of this application to mean the transmission of a movement/vibration to the user, this movement/vibration preferably having a frequency in the infrasound and/or the so-called deep low frequencies. Thus, such a vibratory stimulus can have a frequency comprised between 1 Hz and 100 Hz, or even between 5 Hz and 50 Hz.

These electromagnetic transducers typically comprise a housing in which a flyweight is mounted such that it is capable of moving in translation inside said housing, and an electromagnet system for displacing the flyweight. However, given the relatively large mass of such a flyweight, the current required to displace it is relatively high and the electromagnet is subject to significant heating which can be a source of discomfort for the user.

This problem is partially solved, as shown in particular in the U.S. Pat. No. 4,354,067, by thermally coupling the coil of the electromagnet to the housing and by providing a housing that is at least partially made of a thermally conductive material. In this way, the thermal energy generated when current is supplied to the electromagnet can be at least partially dissipated by the housing made of a thermally conductive material.

Nonetheless, while such a solution allows the rise in the temperature of the electromagnetic transducer to be limited, it is not entirely satisfactory, since the thermal dissipation is achieved through the housing. As a result, some of the heat dissipated via the housing is in contact with the user, who is thus still subject to relatively high heating despite the optimisation of the thermal dissipation.

There is thus currently no electromagnetic transducer for a stimulation system, such as a massage device, that is free from such a problem where the user is subjected to the heat generated by the electromagnet upon activation thereof while improving the reliability of the electromagnetic transducer.

### DISCLOSURE OF THE INVENTION

Thus, the invention aims to overcome the aforementioned problem by providing an electromagnetic transducer that provides protection to the user, protecting the latter from the heat emitted by the electromagnet, and in particular by the coil thereof, as well as providing thermal protection for the electromagnetic transducer during its activation, thus increasing the reliability of the electromagnetic transducer.

For this purpose, the invention relates to an electromechanical transducer for transmitting a vibratory stimulus to a user, the electromechanical transducer being intended to be housed inside a packing of a stimulation system with a support face flush with said packing for transmitting the stimulus to a user of said stimulation system, the electromechanical transducer comprising:
a housing with the support face,
a movable element mounted such that it is capable of being moved in translation inside the housing by means of at least a first elastic return element,
an electromagnetic actuation system, configured to set the movable element in motion, the actuation system comprising an electromagnet and at least a first magnet.

The electromagnet is integral with the movable element and the magnet is integral with the housing.

The first elastic return element comprises a thermally insulating material, and the electromechanical transducer further comprises a heat-sensitive element associated with the electromagnet.

With such a configuration, the electromagnet being integral with the movable element and the movable element itself being thermally insulated from the housing by the first elastic return element, the heat escaping towards the user is thus reduced.

Moreover, the provision of a heat-sensitive element associated with the electromagnet allows both the user to be protected and the transducer to be operated correctly. More specifically, such a heat-sensitive element allows the current transmitted to the electromagnet to be limited, or even cut off, in the event of the electromagnet becoming heated, which could result in a rise in the temperature of the housing that is potentially a source of discomfort for the user or cause the transducer to malfunction.

Thus, with such a combination of thermal insulation and thermal protection procured by the heat-sensitive element, the user can be protected from the discomfort that could be caused by the heat emitted by the electromagnet of the electromagnetic transducer during its activation.

It should also be noted that, with such a configuration wherein the electromagnet is integral with the movable element, the risks of damage being caused to the electromagnet by the movable element during its displacements are avoided. This results in increased reliability compared to the electromagnetic transducers of the prior art, in which the electromagnet is arranged integral with the housing and is thus at risk of becoming damaged during the displacements of the movable element.

The term ‘packing of the stimulation system’ must be understood hereinabove and in the remainder of this document to mean the material constituting at least one internal part of the stimulation system, such as a foam of a massage table or chair, when the stimulation system is a massage table or chair, or the material constituting a wall, when the stimulation system is a wall equipped with transducers according to the invention. It goes without saying that such a packing may or may not be associated with a covering, such as a fabric or a leather covering for a chair, or a wallpaper for a wall.

“Thermal insulation” must be understood hereinabove and in the remainder of this document to mean a material with a thermal conductivity of less than 1 W·m⁻¹·K⁻¹.

The housing can comprise a cover with the support face and a body closed by said cover, the movable element being mounted such that it can move relative to the body.

The cover can comprise at least one part that is capable of moving relative to the body.

The movable part of the cover can be connected to the body by means of a second elastic return element, the assembly formed by the movable part of the cover and the second elastic return element having a resonant frequency greater than a resonant frequency of the assembly formed by the movable element and the first elastic return element.

It should be noted that such a second elastic return element can be provided by a peripheral part of the cover which is thinned and/or specially shaped with respect to the movable part which is central.

In an alternative to this possibility, the second elastic return element can be an element that is separate from the movable part.

In such a configuration, the cover is able to be displaced by being driven by the displacement of the movable element and/or the magnetic flux variations generated by the electromagnet.

Thus, such a second elastic return element allows the movable element and the movable part of the cover to have different resonant frequencies, thus allowing the transducer to have a higher bandwidth in terms of the frequency of movement that can be transmitted to the user.

In either of these configurations, the cover is able to contribute to the transmission of the movement of the movable element in order to produce a vibratory stimulus that can be used according to the cases of use stipulated in the preamble.

The electromechanical transducer can further comprise a displacement sensor arranged inside the housing and configured to provide a signal relative to the displacement of said housing.

Such a displacement sensor can provide information about both the orientation of the housing and the amplitude of the movement transmitted to the user. This information can then be used to optimise the simulation of the massaging gesture applied to the user.

Such a displacement sensor can be a displacement sensor in itself, such as a capacitive sensor or a sensor for indexing a displacement, an orientation change sensor, such as a gyrometer or gyroscope, or an accelerometer, or even a combination of a plurality of sensors.

The displacement sensor can be integral with the cover.

In this way, the displacement sensor is able to transmit information about the movement of the cover.

The heat-sensitive element can be selected from among temperature-controlled, preferably automatic reset, switches and temperature sensors.

Such heat-sensitive elements are particularly adapted for limiting or even cutting off the power supply to the electromagnet.

The heat-sensitive element can be associated with a threshold temperature from which the power supply to the electromagnet is limited or even cut off.

The movable element can comprise a core of the electromagnet, said core comprising at least one hollow shape such as a tubular shape.

Such a hollow-shaped core allows the performance levels of the electromagnet to be optimised while limiting eddy current phenomena that could cause disruption thereto.

The core can include a winding of at least one sheet made of a ferrous material, with two successive windings being separated from one another by a dielectric material.

Such a winding is particularly adapted for limiting eddy current phenomena.

The housing can include, at the support face, an interface element comprising at least one elastomer, said interface element being intended to rest, through an optional covering, against the user in order to transmit the vibratory stimulus to the user.

Said elastomer can be a silicone, a natural rubber or a synthetic rubber.

Such an interface element provides a thermally insulating layer at the support face limiting heat transmission from the housing to the user. The user's comfort is thus preserved.

It should be noted, moreover, that such an interface element can further limit the transmission of audible sound frequencies that could be generated by the displacement of the movable element and/or a potential movable part of the cover.

The interface element can comprise a plurality of cavities.

Such cavities provide additional damping and thermal insulation to the interface element compared to an interface element devoid of such cavities.

Given that the housing includes a body and a cover that has the support face, the body can comprise openings on a face opposite the cover.

Such openings, or vents, allow for fluid communication between the recess formed by the housing and the exterior of the housing, thus allowing a part of the thermal energy generated by the electromagnet to escape.

The invention further relates to a stimulation system intended to provide vibratory stimuli to a user comprising a packing and at least one electromechanical transducer according to the invention, said at least one transducer being housed inside the packing with a support face flush with said packing.

Such a stimulation system benefits from the advantages of the electromechanical transducer with which it is equipped.

The heat-sensitive element of the one or of each electromechanical transducer can be a temperature sensor and the stimulation system can further comprise at least one control unit of the one or more electromechanical transducers configured to supply power to the electromagnet of the one or more electromechanical transducers, the control unit being further configured to retrieve a temperature signal provided by the one or more temperature sensors and, when one or more temperature signals provided by the one or more temperature sensors correspond to a temperature greater than or equal to, or even strictly greater than, a threshold temperature, to limit, or even cut off, the power supply to the one or more electromagnets for which the temperature signals provided by the one or more temperature sensors correspond to a temperature greater than or equal to the threshold temperature.

Such a configuration of the stimulation system allows the power supply to the electromagnet to be adapted in the event of overheating. This avoids any risk of discomfort to the user, even when the electromagnetic transducer is under high loading.

The stimulation system can be a vehicle seat, said seat preferably being intended to equip an aircraft.

Such a stimulation system more particularly benefits from the advantages of the invention.

The invention further relates to a vehicle comprising a stimulation system according to the invention.

Such a vehicle offers these passengers the benefits of the stimulation system with which it is equipped.

### BRIEF DESCRIPTION OF THE DRAWINGS

The present invention will be better understood after reading the following description of example embodiments, which is intended for purposes of illustration only and is not intended to limit the scope of the invention, and with reference to the accompanying drawings, wherein:

FIG. 1 shows a stimulation system, in this case a massage chair for an aircraft, according to the invention, equipped with four electromagnetic transducers according to the invention.

FIG. 2 shows a diagrammatic sectional view of an electromagnetic transducer according to a first embodiment, wherein a cover of a housing of said transducer is integral with a body of this same housing.

FIG. 3 shows a diagrammatic sectional view of an electromagnetic transducer according to a second embodiment, wherein the cover of the housing of the transducer is mounted such that it can move in translation relative to the body of the housing.

FIG. 4 shows a diagrammatic sectional view of an electromagnetic transducer according to a third embodiment, wherein the cover comprises a central part that is capable of moving relative to the body thanks to an elastic return element.

Identical, similar or equivalent parts of the different figures carry the same numerical references in order to ease the passage from one figure to another.

The different parts shown in the figures are not necessarily displayed according to a uniform scale in order to make the figures easier to read.

The different possibilities (alternatives and embodiments) must be understood as not being exclusive with regard to one another and can be combined together.

### DESCRIPTION OF THE EMBODIMENTS

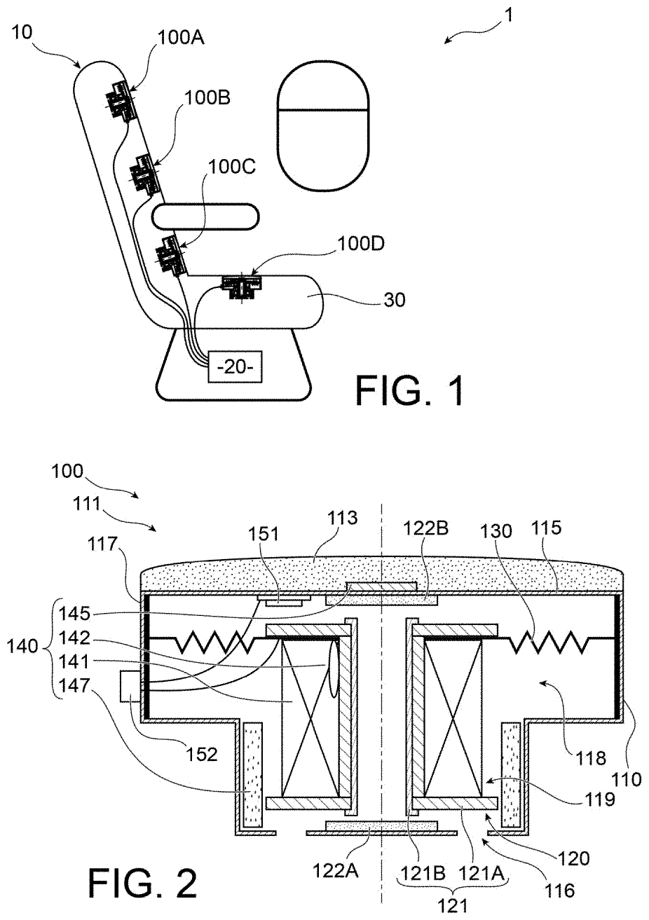

FIG. 1 shows, by way of a diagrammatic view, an aircraft chair, in the form of a stimulation system 10, comprising four electromagnetic transducers 100A, 100B, 100C, 100D housed inside a packing 30 of the aircraft chair, said chair being installed inside an aircraft 1.

It should be noted that, although in the present example the stimulation system 10 is an aircraft chair, it goes without saying that the invention is not limited to this application alone and concerns any type of stimulation system 10 intended to transmit vibratory stimuli and which is capable of including such electromagnetic transducers 100A, 100B, 100C, 100D. Thus, according to non-illustrated and non-limiting possibilities, the stimulation system 10 can also be a motorised land or sea vehicle chair, an office chair or a massage table or bed, equipped with said electromagnetic transducers to provide, by means of the transmission of vibratory stimuli provided by the electromagnetic transducers, a massage or a sensory signal to the user of said stimulation system, without leaving the scope of the invention.

Moreover, although such transducers are in particular intended to massage users of said stimulation systems 10, other applications can easily be conceived, without leaving the scope of the invention. In particular, such transducers can be used within the scope of user entertainment, such as video game activities or the consumption of multimedia content, the transducers being able to apply infrasound or low-frequency stimulation in connection with said activities. According to another possible application of the invention, such transducers can be used to transmit information to the user of said stimulation system 10, such as, for example and within the scope of an application to an aircraft pilot's chair, force feedback relating to aircraft handling commands or flight information.

Similarly, although such stimulation systems are generally furniture or even chairs, other types of stimulation systems can be conceived without leaving the scope of the invention. Thus, such a stimulation system 10 can be a wall or a floor, including in their packing 30 (i.e. their internal material of said wall or floor), an electromagnetic transducer 100A, 1006, 100C, 100D for transmitting a vibratory stimulus to the user when he/she comes into contact with a part of said wall or floor equipped with said electromagnetic transducer 100A, 1006, 100C, 100D.

It should be noted that FIG. 1 shows, in addition to the four electromagnetic transducers 100A, 1006, 100C, 100D which are integrated into the packing 30 of the chair, a control unit 20 for said transducers capable of providing a control signal to said electromagnetic transducers 100A, 1006, 100C. Such a configuration of the control unit 20 is, of course, only an example, and other configurations can easily be conceived without leaving the scope of the invention, the control unit 20 being able, for example, to be integrated into a centralised control unit of a vehicle or provided in two parts, a respective sub-unit integrated into each electromagnetic transducer 100A, 1006, 100C, 100D and a central unit connected to said control sub-units.

Similarly, the configuration of the electromagnetic transducers 100A, 1006, 100C, 100D shown in FIG. 1 is given only as an example and is by no means limiting. Thus, if the chair comprises four electromagnetic transducers 100A, 1006, 100C, 100D distributed along the backrest and the seat cushion, it is entirely possible for them to be distributed differently. For example, the electromagnetic transducers 100A, 1006, 100C, 100D can be arranged in pairs and distributed on either side of an axis of symmetry of the chair with a similar distribution along the backrest and the seat cushion (i.e. a configuration with 8 electromagnetic transducers), or one large electromagnetic transducer 100A, 1006, 100C, 100D for the seat cushion and 6 smaller electromagnetic transducers 100A, 1006, 100C, 100D for the backrest.

Within the scope of a first embodiment and as shown in FIG. 2, the electromagnetic transducer 100 comprises:

a housing 110 with the support face 111,

a movable element 120 housed inside the housing 110 and mounted in the housing 110 such that it can be moved in translation by means of a first elastic return element 130 made of a thermally insulating material, and

an electromagnetic actuation system 140, configured to set the movable element in motion, the actuation system comprising an electromagnet 141 and a first magnet 145, the electromagnet 141 including a heat-sensitive element 142.

In accordance with the invention, the electromagnet 141 is integral with the movable element 120 and the first magnet 125 is integral with the housing 110.

In the present embodiment, the housing 110 comprises a cover 115 having the support face 111 and a body 117 closed by said cover 115, the cover 115 being integral with the body 117.

The body 117 has a main recess 118, bounded in part by the cover 115 and a secondary recess 119, opposite the cover 115. As shown in FIG. 2, the main recess 118 and the secondary recess 119 are each rotationally cylindrical in shape and communicate with one another at a common open base which, in the case of the main recess, is opposite the cover 115. It goes without saying that other shapes of the body 117 can easily be conceived without leaving the scope of the invention.

Preferably, the body 117 and the cover 115 are made of a ferromagnetic material.

According to one possibility of the invention considered in the present embodiment, the body can comprise openings 116, or vents, on a face opposite the cover. Such openings 116 allow for fluid communication between the secondary recess 119 and the exterior of the body, thus allowing a part of the thermal energy generated by the electromagnet 141 to escape during the operation of the electromagnetic transducer 100.

It should be noted that, within the scope of an application of the invention wherein the stimulation system 10 is fitted to an aircraft, the openings 116 can be chosen to be reduced in size or have a metal mesh in order to provide electromagnetic shielding and thus avoid emitting to the exterior of the housing 110 any electromagnetic interference that the electromagnetic actuation system 140 could generate. In accordance with such an application, both the body 117 and the cover 115 can be made of electrically conductive materials.

Within the scope of this first embodiment, the movable element 120 comprises:

the electromagnet 141, comprising a coil made of an electrically conductive material, such as copper, and including the heat-sensitive element 142, and

a core 121, made of a ferromagnetic material, of the electromagnet 141.

Thus, in the present disclosure, for simplicity purposes and to avoid imprecisions, the electromagnet 141 is referred to solely via its coil, the core 121 being described independently from the rest of the electromagnet 141.

As shown in FIG. 1, the core 121 has a hollow, rotationally cylindrical shape with an open base which can also be defined as tubular, the bases of said cylinder having radial extensions so as to define, along the sidewall thereof, a recess for the coil of the electromagnet 141.

According to one possibility of the invention, in accordance with the present embodiment, the core 121 can be in two parts, an outer cylinder 121A with the radial extensions, and an inner cylinder 121B enclosed within the outer cylinder. According to this possibility and in order to limit eddy currents, the outer and inner cylinders 121A, 121B of the core are electrically insulated from one another, for example by means of a layer of dielectric material disposed therebetween. It should be noted that, in the example of this first embodiment, the hold between the one outer cylinder 121A and the inner cylinder 121B is achieved by a crimped connection at the base of the inner cylinder 121B. Other holding systems, such as a force fit, can also be considered without leaving the scope of the invention.

Alternatively, and according to an advantageous configuration not shown, the core 121 can comprise a winding of at least one sheet made of a ferrous material, with two successive windings being separated from one another by a dielectric material. Such a winding can, for example, be formed by winding a single sheet made of a ferrous material coated with the dielectric material such as a varnish. According to this same alternative, in accordance with the possibility of this first embodiment according to which the core 121 can be in two parts, at least one of the outer cylinder 121A and the inner cylinder 121B can comprise such a winding.

It should also be noted that, although in the present embodiment, the movable element 120 comprises only the coil of the electromagnet 141 and the core 121, it is also conceivable, without leaving the scope of the invention, for the movable element 120 to comprise an insert made of a non-magnetic material, this insert being inserted into the core in order to increase the mass of the movable element 120. Similarly, it is conceivable, without leaving the scope of the invention, for the movable element, and thus the electromagnet 141, to be devoid of a core 121.

The heat-sensitive element 142 is, in the present embodiment, associated with the electromagnet 141 by being positioned between the coil of the electromagnet 141 and the core 121, or only in the coil to prevent excessive heating of the electromagnet coil wire. Such a combination allows the heat-sensitive element 142 to be subjected to the temperature variations of the electromagnet 141. It goes without saying that another arrangement/association between the heat-sensitive element 142 and the electromagnet 141 can be conceived without leaving the scope of the invention. Thus, for example, in the case where the heat-sensitive element 142 is a remote temperature sensor, such as an infrared temperature sensor, the heat-sensitive element 142 can be arranged on the wall of the housing 110 facing the electromagnet 141 so as to allow the temperature of the electromagnet 141 to be measured.

According to one possibility of the invention considered in the present embodiment, the heat-sensitive element 142 can be a temperature sensor connected to the control unit 20 and associated with a threshold temperature from which the control unit reduces, or even cuts off, the power supply to the electromagnet 141 and thus reduces the thermal energy released thereby. Thus, the control unit 20 is configured to retrieve the temperature signal provided by the heat-sensitive element and to limit or even cut off the power supply to the electromagnet 141 when the signal provided by the heat-sensitive element corresponds to a temperature that is greater than or equal to, or even strictly greater than, the threshold temperature.

According to this same possibility, the temperature sensor can be associated with two threshold temperatures, a first relatively low threshold temperature, for example, less than or equal to 50° C. or even 60° C., from which the power supply to the electromagnet 141 is limited, and a second relatively high threshold temperature, for example, greater than or equal to 80° C. or even 100° C., from which the power supply to the electromagnet 141 is cut off, the latter being resumed only in a limited manner when the temperature passes a third, intermediate threshold temperature between said first and second threshold temperatures.

According to another possibility, not shown, the heat-sensitive element 142 can be a temperature-controlled, preferably automatic reset switch, such as an automatic reset thermal cut-out, also known as a polyswitch fuse. According to this other possibility, the heat-sensitive element 142 is arranged in series with the electromagnet such that the power supply to the electromagnet is cut off when the thermal cut-out reaches a threshold temperature.

Regardless of the selected configuration of the heat-sensitive element 142, the threshold temperature with which the heat-sensitive element is associated is preferably less than or equal to 100° C., or even less than or equal to 70° C., or even less than or equal to 60° C.

It should be noted that said threshold temperature can be selected as a function of the desired type of protection. More specifically, a temperature of 100° C. is particularly adapted for protecting the electromagnet 141 and in particular the dielectric material used for the winding of the coil of the electromagnet 141, whereas a temperature of 60° C. is more adapted when looking to preserve the user's comfort as much as possible (a temperature of 100° C. is nonetheless acceptable, in particular as a result of the use of an interface element 113, as discussed hereinbelow).

In order to allow the electromagnet 141 and thus the movable element to be displaced relative to the housing 110, the first magnet 145 can be arranged on one face of the cover 115, in the present embodiment, the support face 111, by being integral therewith, or on one of the faces of the housing 110 which is opposite the cover 115.

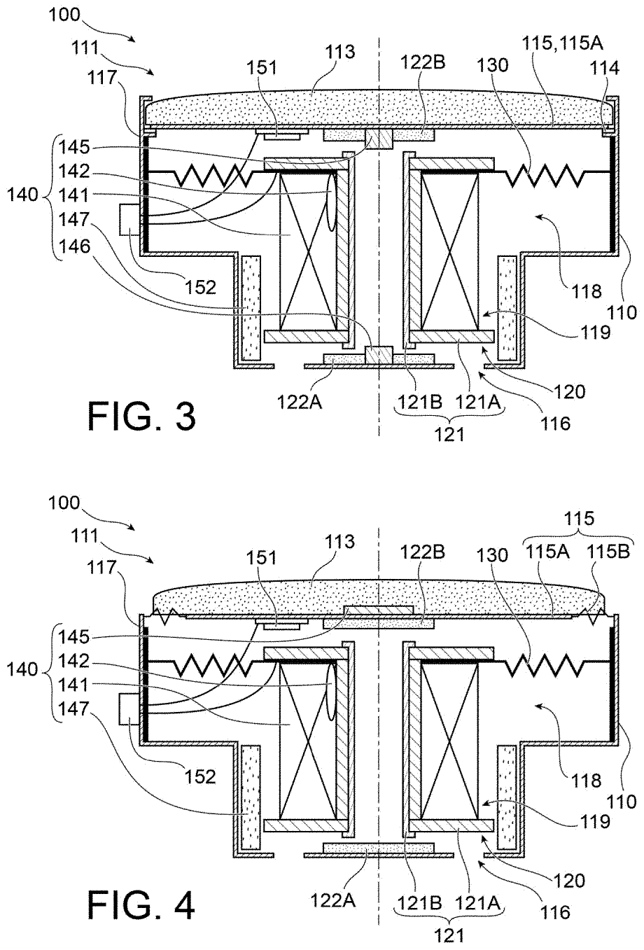

It should be noted that, although in the present embodiment, the first magnet 145 is arranged on an outer face of the cover 115, it is also conceivable, without leaving the scope of the invention, for the first magnet to be arranged on an inner face of said cover, as described hereinbelow within the scope of the second embodiment and shown in FIG. 3. Similarly, when the magnet is arranged on one of the faces of the housing 110, opposite the cover, this face can be either an outer face or an inner face of said housing 110.

According to another alternative embodiment which will also be described within the scope of the second embodiment, the electromagnetic actuation system 140 can include, in addition to the first magnet 145, a second magnet 146 integral with one from among a face of the cover 115 and one of the faces of the housing 110 which is opposite the cover 115, as shown in FIG. 3, the first magnet 145 being integral with another one from among a face of the cover 115 and one of the faces of the housing 110 which is opposite the cover 115. With such an alternative embodiment, the efficiency of the electromagnetic actuation system 140 is increased and first and second magnets 145, 146 having reduced dimensions can be used.

As shown in FIG. 2, the movable element 120 is housed partially inside the main recess 118 and partially inside the secondary recess 119.

In order to guide the movable element 120 during the translation thereof, the secondary recess 119 can be equipped with guide elements 147, such as a sliding bearing, along which a part of the movable element 120, in this case a radial extension of the core 121, slides during the translational displacement of the movable element 120. Such sliding bearings can be provided by a polyamide, such as nylon, or by a polyoxymethylene, also known as POM.

The movable element 120 is connected to the walls of the main recess 118 by means of the first elastic return element 130. The first elastic return element 130 comprises at least one thermally insulating material to limit the transmission of thermal energy from the movable element 120 (to be more precise from the electromagnet 141) to the housing 110. This same insulating material is also preferably non-magnetic, in order to avoid any interference with the electromagnetic actuation system 140, and more precisely to not short-circuit the magnetic flux of the core between the electromagnet 141 and the first magnet 145 which produces the attraction-repulsion effect.

Thus, the first elastic return element 130 can, for example, comprise a resin, such as a poly(methyl methacrylate) resin, alone or impregnated into a fibrous or fabric support.

In accordance with the present embodiment, the housing 110 can comprise at least one damper 122A, 122B disposed such that it is sandwiched between the housing and the movable element during a potential extreme displacement. Thus, as shown in FIG. 2, the housing 110 can comprise a first and a second damper 122A, 122B, the first damper 122A on an inner face of the cover 115 facing the movable element 120, and the second damper 122B on an inner face of the body 117 opposite the inner face of the cover 115.

Thus, the damper 122A, 122B can comprise an elastomer, such as a silicone or a rubber (natural or synthetic).

The movable element 120, the first elastic return element 130 and the one or more dampers 122A, 122B can be configured such that the movable element 120 has a resonant frequency comprised between 1 and 100 Hz, or even between 5 and 50 Hz, and preferably between 10 and 30 Hz.

In order to provide additional thermal insulation, the housing 110 can include, as shown in FIG. 2, at the support face 111, the interface element 113 comprising at least one elastomer, said interface element 113 being intended to rest, through an optional covering, against the user in order to transmit the movement of the movable element 120 thereto.

According to one possibility not shown, the interface element can comprise a plurality of cavities. Such cavities provide additional damping and thermal insulation to the interface element compared to an interface element devoid of such cavities.

It should also be noted that, in order to determine the orientation of the electromagnetic transducer 100 and/or to determine the intensity of the displacements of the movable element, the electromagnetic transducer can comprise a displacement sensor 143 arranged inside the housing and configured to provide a signal relative to the displacement of the housing. The displacement sensor can thus be selected from the group comprising accelerometers, pyrometers and gyroscopes.

As shown in FIG. 1, the displacement sensor 151 can be, for example, arranged such that it is integral with the cover 115 or, according to a possibility not shown, such that it is integral with the body 117.

With the electromagnetic transducer 100 being equipped in this manner, the control unit 20 is able to determine information concerning the electromagnetic transducer 100 and the stimulation system 10, such as the orientation of the stimulation system 10, the installation of a new user on said stimulation system 10, or an estimation of the corpulence of said user, and thus adapt the mode of operation of the one or of each electromagnetic transducer as a function of the information determined. This same information can also be used to adjust certain environmental parameters of the stimulation system 10, such as the orientation of one or more lights, of an air flow or of equipment such as a screen.

In the present embodiment, both the displacement sensor 151 and the heat-sensitive element 142 are connected to a connector 152 passing through the housing 110 to allow for connection to the control unit 20. This same connector 152 is also used to connect the electromagnet 141 to the control unit in order to allow it to be powered thereby.

FIG. 3 shows an electromagnetic transducer 100 according to a second embodiment, wherein the cover 115 comprises at least one part 115A that is capable of moving relative to the body 117, such that the displacement of the movable element 120 causes said movable part 115A of the cover 115 to be displaced.

An electromagnetic transducer 100 according to this second embodiment differs from an electromagnetic transducer 100 according to the first embodiment in that the cover 115 is capable of moving relative to the body 117 of the housing 110, in that the first magnet 145 is arranged on an inner face of the cover 115 housed inside the damper 122B, and in that a second magnet 146 is arranged on an inner face of the body 117 housed inside the damper 122A.

Thus, according to this second embodiment, the cover 115 is arranged such that it can move in translation relative to the body 117 of the housing 110, such that the displacement of the movable element causes the cover 115 to be displaced. For this purpose, the body can include, as shown in FIG. 3, abutments, which can limit the amplitude of displacement of the cover 115 relative to the body 117. According to this possibility, and as shown in FIG. 3, a peripheral seal 114 sandwiched between the cover 115 and one of the abutments (in this case the lower abutment) can also be provided, in order to reduce, or even eliminate, the emission of noise that could be generated by the displacement of the cover 115.

The cover 115 can be shaped such that it has a resonant frequency comprised between 50 and 150 Hz, preferably between 75 and 125 Hz. In this way, by having a resonant frequency that is distinct from that of the movable element 120, whether or not it corresponds to a harmonic of the resonant frequency of the movable element 120, the electromagnetic transducer 100 is able to provide a vibratory stimulus over a wider frequency range and thus facilitate relaxation of the user.

FIG. 4 shows an electromagnetic transducer 100 according to a third embodiment, wherein the cover 115 comprises a second elastic return element 115B connecting the movable part 115A of the cover 115 to the body 117.

An electromagnetic transducer 100 according to a third embodiment differs from an electromagnetic transducer 100 according to the first embodiment in that it comprises the second elastic return element 115B and in that a movable part 115A of the cover is displaced relative to the body 117 by the deformation of said second elastic return element 115B.

According to a first possibility of the present embodiment, as shown in FIG. 4, the second elastic return element 115B and the movable part 115B can be provided in the form of two parts separate from one another, one constituting the second elastic return element and the movable part forming the cover as such. According to this possibility, the second elastic element comprises a ferromagnetic material, such as a ferrous filler of a resin, to provide magnetic continuity between the body 117 and the movable part 115B of the cover 115.

Alternatively, according to a possibility not shown, the cover 115 can be formed in one piece with a variable thickness or an adapted shape with a central part, forming the movable part 115A, and a peripheral part 115B, designed by the thickness or shape thereof, to form the second elastic return element, via which the cover 115 is connected to the body 111. Thus, the peripheral part 115B can have a relatively small thickness and/or a specific shape with respect to the movable part 115A. In this way, due to the relatively small thickness and/or the shape thereof, the peripheral part has sufficient elasticity to form the second elastic return element 115B and the movable part 115A has, due to the relatively large thickness thereof, sufficient rigidity to transmit a movement to the user.

1. Electromechanical transducer for transmitting a vibratory stimulus to a user, the electromechanical transducer being intended to be housed inside a packing of a stimulation system with a support face flush with said packing for transmitting the vibratory stimulus to the user of said stimulation system, the electromechanical transducer comprising:
a housing with the support face;
a movable element mounted such that it is capable of being moved in translation inside the housing by means of at least a first elastic return element;
an electromagnetic actuation system, configured to set the movable element in motion, the actuation system comprising an electromagnet and at least a first magnet, the electromagnetic transducer, wherein the electromagnet is integral with the movable element and in that the magnet is integral with the housing, and wherein the first elastic return element comprises a thermally insulating material having a thermal conductivity of less than 1 Wm⁻¹K⁻¹; and
a heat-sensitive element associated with the electromagnet that is selected from among temperature-controlled switches and temperature sensors, the heat-sensitive element being adapted to allow the power supply to the electromagnet to be limited or cut off.

2. Electromechanical transducer according to claim 1, wherein the housing comprises a cover with the support face and a body closed by said cover, the movable element being mounted such that it can move in translation relative to the body, and wherein the cover comprises at least one part that is capable of moving relative to the body.

3. Electromechanical transducer according to claim 2, wherein the movable part of the cover is connected to the body by means of a second elastic return element, the assembly formed by the movable part of the cover and the second elastic return element having a resonant frequency greater than a resonant frequency of the assembly formed by the movable element and the first elastic return element.

4. Electromechanical transducer according to claim 1 further comprising a displacement sensor arranged inside the housing and configured to provide a signal relative to the displacement of the housing.

5. Electromechanical transducer according to claim 1, wherein the movable element comprises a core of the electromagnet, said core comprising at least one hollow shape such as a tubular shape.

6. Electromechanical transducer according to claim 1, wherein the housing includes, at the support face, an interface element comprising at least one elastomer, said interface element being intended to rest, through an optional covering of the stimulation system, against the user in order to transmit the vibratory stimulus to the user.

7. Stimulation system intended to provide vibratory stimuli to a user and comprising a packing and at least one electromechanical transducer according to claim 1, said at least one electromagnetic transducer being housed inside the packing with a support face flush with said packing.

8. Stimulation system according to claim 7, wherein the heat-sensitive element of the one or of each electromechanical transducer is a temperature sensor and wherein the stimulation system further comprises at least one control unit of the one or more electromechanical transducers configured to supply power to the electromagnet of the one or more electromechanical transducers, the control unit being further configured to retrieve a temperature signal provided by the one or more temperature sensors and, when one or more temperature signals provided by the one or more temperature sensors correspond to a temperature greater than or equal to, or even strictly greater than, a threshold temperature, to limit, or even cut off, the power supply to the one or more electromagnets for which the one or more temperature signals provided by the one or more temperature sensors correspond to a temperature greater than or equal to the threshold temperature.

9. Stimulation system according to claim 8, wherein the stimulation system is a vehicle seat, said seat preferably being a seat intended to equip an aircraft.

10. Vehicle comprising a stimulation system according to claim 1.
